(19) United States
(12) Patent Application Publication
(10) Pub. No.: US 2016/0055446 A1
(43) Pub. Date: Feb. 25, 2016

(54) OPTIMIZED SELECTION OF PROJECT TEAM

(71) Applicant: Oracle International Corporation, Redwood Shores, CA (US)

(72) Inventors: Aditya SEN, Kolkata (IN); Manish KUMAR, Bangalore (IN); Priyamvada TIWARI, Bangalore (IN); Raghavan SRINIVASAN, Bangalore (IN); Sivashanmuganathan NARAYANASAMY, Bangalore (IN); Vaibhav APARIMIT, Bangalore (IN)

(21) Appl. No.: 14/466,301

(22) Filed: Aug. 22, 2014

(51) Int. Cl. G06Q 10/06

(52) U.S. Cl. CPC G06Q 10/063118; G06Q 10/06313

(57) ABSTRACT

A resource staffing manager is provided that manages resource staffing of project teams. Requirements for one or more positions to be staffed for a project team and a budget for staffing the project team are received. For each position, eligible resources that meet the requirements of the position are selected. Based on a selected optimization method, optimal resource assignments for the project team are determined such that the optimal resource assignments include, for each position, a resource assignment of one of the corresponding eligible resources to the position. A GUI is displayed that includes the positions, the optimal resource assignments, and the eligible resources. Modified requirements for a position can be received, and, in response, the eligible resources are updated, updated optimal resource assignments are determined based on the updated eligible resources, and the GUI is updated to reflect the modified position requirements and display the updated optimal resource assignments.

### FIELD

One embodiment is directed generally to a computer system, and in particular to a computer system that displays a graphical user interface for optimized selection of a project team.

### BACKGROUND INFORMATION

A responsibility of a project manager is to forecast the resource demand profile that will be required by a project before the work begins. The resource demand profile can be defined as the roles, skills and number of resources that will be necessary to complete the work on a project. The project manager may work in conjunction with other members of the Project Management Office (“PMO”), the planner/scheduler, and/or field personnel to create this resource demand profile at the project level, and then work together with resource managers and procurement managers to fulfill the resource needs of the project in a timely fashion.

The staffing can be done by running a manual search on each of the requirements. The search then generates a list of resources to choose from based on their availability. Then, the project/resource manager could choose from the list of resources and could choose to staff the corresponding role requirement.

Resource finding is one of the key areas in staffing the resource demand profile requirements of a project, and manually searching for role staffing as described above may be time consuming, inefficient, and/or costly.

### SUMMARY

One embodiment is a system that manages resource staffing. The system receives requirements for one or more positions to be staffed for a project team and an allocated budget for staffing the project team. For each position, the system selects eligible resources that meet the requirements of the position. Based on a selected optimization method, the system determines optimal resource assignments for the project team such that the optimal resource assignments include, for each position, a resource assignment of one of the corresponding eligible resources to the position. The system then displays a graphical user interface (“GUI”) that includes the positions, the optimal resource assignments, and the eligible resources. In some embodiments, the system receives modified requirements for one or more positions, and, in response, updates the eligible resources based on the modified position requirements, determines updated optimal resource assignments based on at least the updated eligible resources and the selected optimization method, and updates the GUI to reflect the modified position requirements and to display the updated optimal resource assignments.

### BRIEF DESCRIPTION OF THE DRAWINGS

FIG. 1 is a block diagram of a computer system that can implement an embodiment of the present invention.

FIG. 2 illustrates a resource demand profile defining resource requirements of a project team, in accordance with one embodiment.

FIG. 3 illustrates a graphical user interface for optimized selection of a project team based on cost optimization, in accordance with one embodiment.

FIG. 4 illustrates an edit requirements dialog of a graphical user interface for optimized selection of a project team, in accordance with one embodiment.

FIG. 5 illustrates a resource details dialog of a graphical user interface for optimized selection of a project team, in accordance with one embodiment.

FIG. 6 illustrates a graphical user interface for optimized selection of a project team indicating user selection of resource “Jef”, in accordance with one embodiment.

FIG. 7 illustrates a graphical user interface for optimized selection of a project team indicating that updated project team assignments are being determined based on a manual user assignment of resource “Jef,” in accordance with one embodiment.

FIG. 8 illustrates a graphical user interface for optimized selection of a project team displaying updated resource assignments determined upon manual user assignment of resource “Jef,” in accordance with one embodiment.

FIG. 9 illustrates an edit requirements dialog of a graphical user interface for optimized selection of a project team including a position requiring multiple skills with equal weighting factors applied by default to each skill, in accordance with one embodiment.

FIG. 10 illustrates an edit requirements dialog of a graphical user interface for optimized selection of a project team including a position requiring multiple skills with varying weighting factors applied to each skill, in accordance with one embodiment.

FIG. 11 is a flow diagram showing the functionality for managing a resource assigning graphical user interface in accordance with one embodiment.

FIG. 12 is a flow diagram showing the functionality for a skills/proficiency optimizer in accordance with one embodiment.

### DETAILED DESCRIPTION

One embodiment is a system that provides a graphical user interface for dynamically searching resources to staff a project team and optimizes the assignment of resources to the project team. The system can determine an optimal combination of resources to staff a project team based on the allocated budget for a project and/or other project variables that are defined in a resource demand profile. The system can determine the optimal combination of resources using a cost optimizer and/or proficiency optimizer, as chosen by a user (e.g., a project/resource manager). The system can enable the user to manually assign a resource and/or manually cancel an assignment and re-calculate the optimal combination taking into account the user's manual selections and the user's chosen optimization method (e.g., by cost and/or by proficiency).

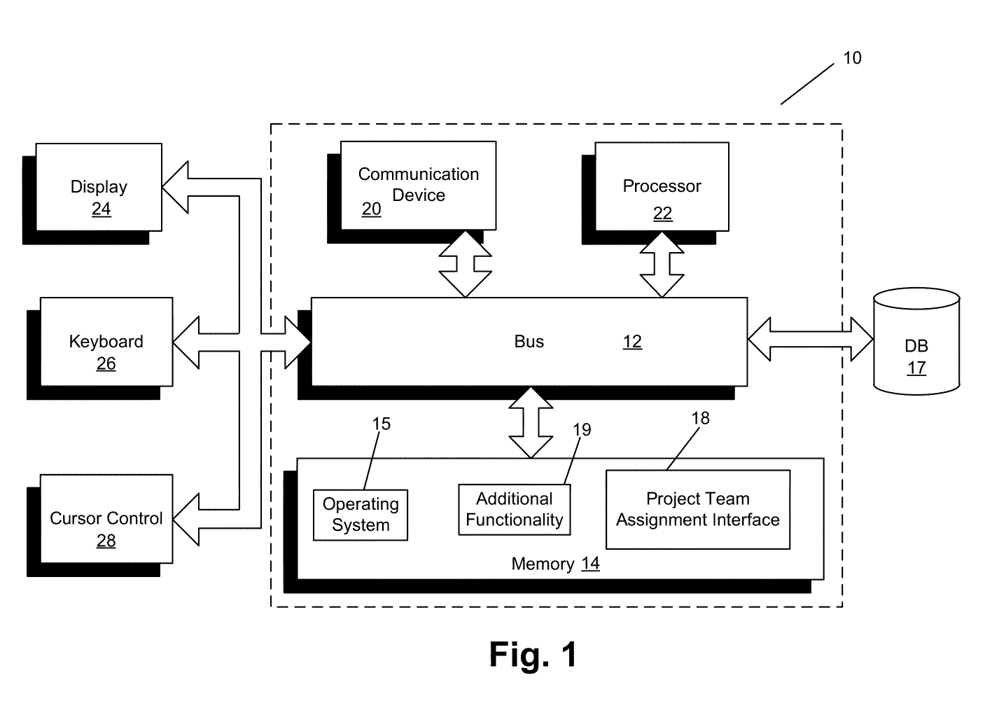

FIG. 1 is a block diagram of a computer system 10 that can implement an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include a project team assignment interface (or “project team assignment optimizer interface”) (or “resource staffing”) module 18 that generates optimal project teams based on a user selected optimization method and/or provides a graphical user interface for assigning resources to a project team, as disclosed in more detail below. System 10 can be part of a larger system, such as an enterprise resource planning (“ERP”) system. Therefore, system 10 will typically include one or more additional functional modules 19 to include the additional functionality. A database 17 is coupled to bus 12 to provide centralized storage for modules 18 and 19 and store project management information, resource information, etc.

In one embodiment, system 10 assists a user (e.g., a project/resource manager) in choosing resources for staffing project team positions by providing a graphical user interface that presents the user with an auto-generated selection (or assignment) of resources that is optimized using a cost optimizer and/or a skills/proficiency optimizer, as chosen by the user. The cost optimizer can, for example, optimize resource selection by cost to select the cheapest resource available that meets a minimum desired proficiency for each position. The proficiency optimizer can, for example, optimize resource selection by proficiencies to select a combination of resources that maximizes total team proficiency while staying within the available budget. The graphical user interface can allow the user to change a position's requirements (e.g., skills, minimum proficiency, start date, finish date, etc.) and then automatically update the auto-generated optimal assignment of resources taking the updated position requirements into account. The graphical user interface can include a screen that includes a list of the positions, a list of eligible resources for each position (i.e., resources meeting the position's requirements), as well as the optimum/assigned choice among those resources. The graphical user interface can allow the user to manually override any assignments and then automatically update the auto-generated optimal assignment of resources taking the user's manual assignments into account to permit the user to see the new optimum team that results after incorporating the repercussions of the change. The graphical user interface can also provide detailed information about each resource from the same screen to help the user to make more informed staffing decisions.

In some embodiments, system 10 can provide a graphical user interface that allows the user to manually assign a particular resource to a position, lock/unlock a resource to a position, and/or cancel a resource with respect to a position. Such embodiments enable a hybrid-optimization by, for example, allowing the user to staff some positions with highly proficient but expensive resources, locking those assignments, and selecting the cost optimizer to cause system 10 to auto-generate assignments for the remaining positions that are the most cost-effective choices.

In some embodiments, system 10 can provide a graphical user interface that allows the user to specify multiple skills for a position, minimum proficiencies for each skill, and weights for each skill.

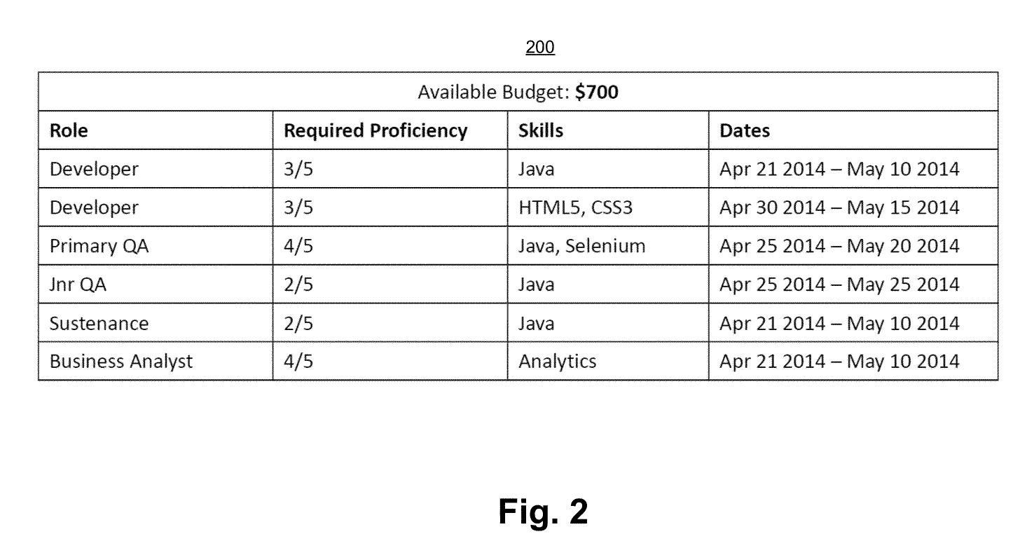

FIG. 2 illustrates a resource demand profile 200 defining resource requirements of a project team, in accordance with one embodiment. Resource demand profile 200 lists the basic resource requirements for a project team (i.e., requirements for each position desired to be filled for the project team) and includes requirements to staff six positions (two developer positions, a primary quality assurance (“QA”) position, a junior QA (or “Jnr QA”) position, a sustenance position (such as, for example, a product support position), and a business analyst (or “BA”) position) with respective skills, required proficiencies, and a duration for which the role is to be staffed to execute the project. Resource demand profile 200 can also include an available budget for staffing the project team positions. Resource demand profile 200 can be defined by a user such as, for example, a project manager or a resource manager.

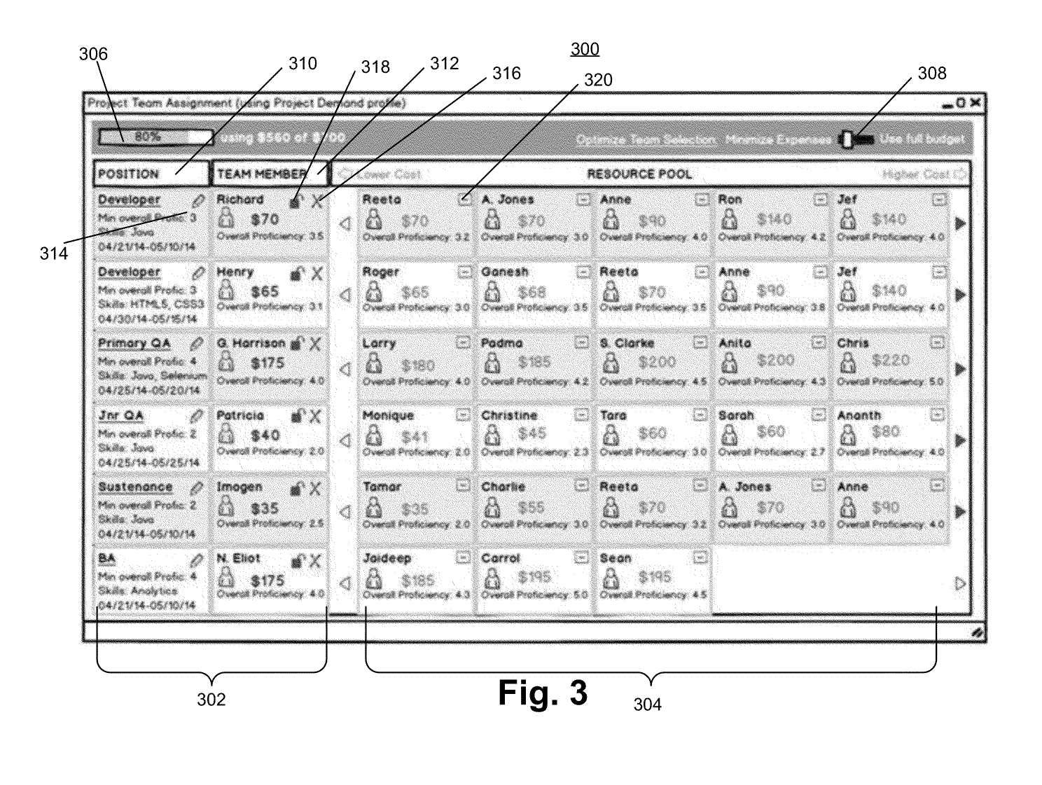

FIG. 3 illustrates a graphical user interface 300 for optimized selection of a project team based on cost optimization, in accordance with one embodiment. Graphical user interface 300 includes a project team grid 302, a resource pool grid 304, a progress bar 306, and an optimization mode slider 308. The two grids (or tables) are laid out side-by-side and each row in the two grids corresponds to a position. Project team grid 302 includes a position column 310 and a team member column 312. The position column 310 cells each show the requirements for the position corresponding to that row. The team member column 312 shows the currently assigned resource for that position (either an auto-generated assignment or a manual assignment). Resource pool grid 304 shows in each row the list of available resources for the position corresponding to that row. Each row of resource pool grid 304 can be ordered, for example, in ascending order by cost or in descending order by proficiency. Progress bar 306 can display the total budget, and how much of it has been consumed by the present assignments. Optimization mode slider 308 can be toggled between optimization modes such as, for example, cost optimization and proficiency optimization.

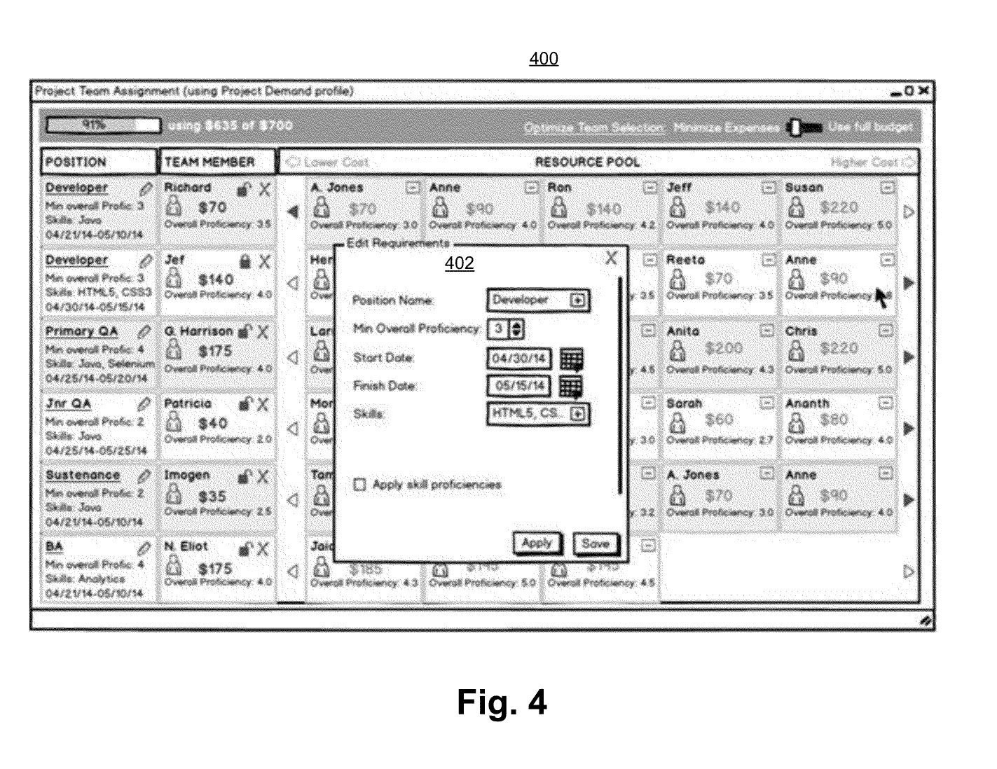

Position column 310 shows the position requirements such as, for example, the role, the minimum proficiency (out of 5), skills, and assignment dates. Each cell can include an edit button 314 at the top right corner that, upon user selection (e.g., clicking), causes a dialog box to be displayed to allow the user to change the requirements, as shown, for example, in FIG. 4 below.

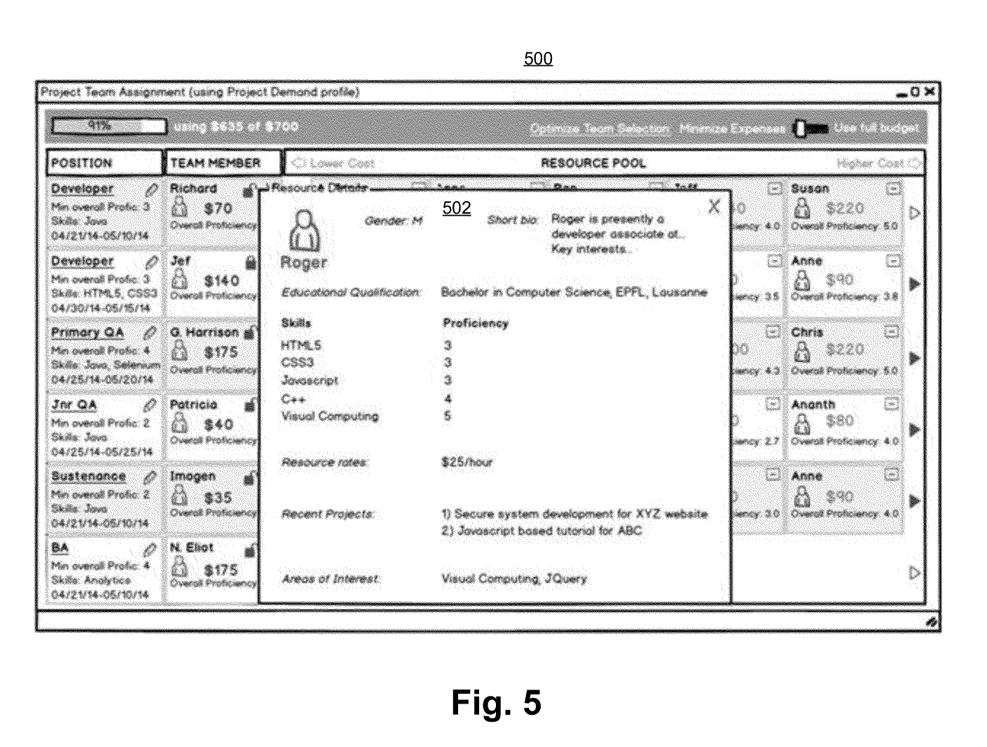

Team member column 312 shows the resource assigned to the position (either an auto-generated assignment or a manual assignment). In some embodiments, cells of team member column 312 can be left blank to indicate that the position is unstaffed. Cells of team member column 312 can display the following details: resource name, cost, and/or proficiency (out of 5). Cells of team member column 312 can include a cross button 316 to cancel the assignment, and a lock/unlock button 318 to hold (or release) the resource in position when the optimizer service runs. Cells of team member column 312 can also include a details button, which launches a details dialog showing more information about the resource, as shown, for example, in FIG. 5. In some embodiments, a user can access the details dialog by clicking the resource's name.

Each row in resource pool grid 304 corresponds to the position shown in position column 310 of project team grid 302. Each row of resource pool grid 304 shows all the resources that fulfil the corresponding position's requirements, and can be sorted, for example, by cost. In some embodiments, when sorting resources by cost, if two resources have the same cost, the one with higher proficiency is ranked ahead. Each cell of resource pool grid 304 displays, for example, the following information about the resource: name, cost, and/or proficiency. Each cell of resource pool grid 304 includes a hide button 320 and a details button (similar to the details button of each cell of team member column 312) which pops up a details dialog showing more information about the resource.

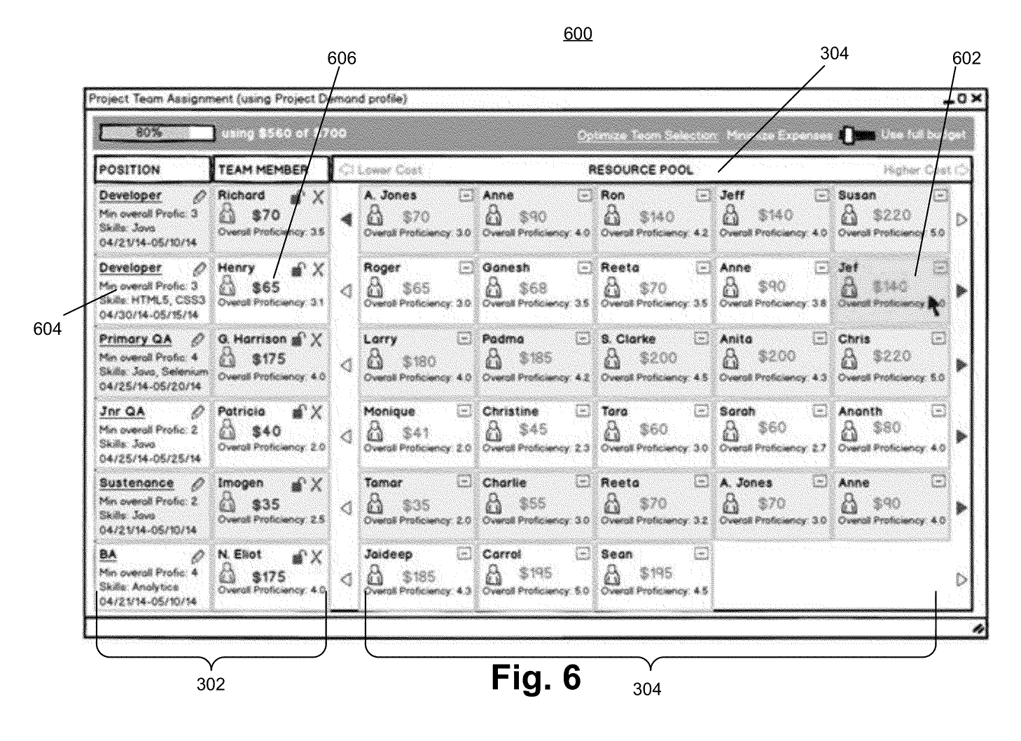

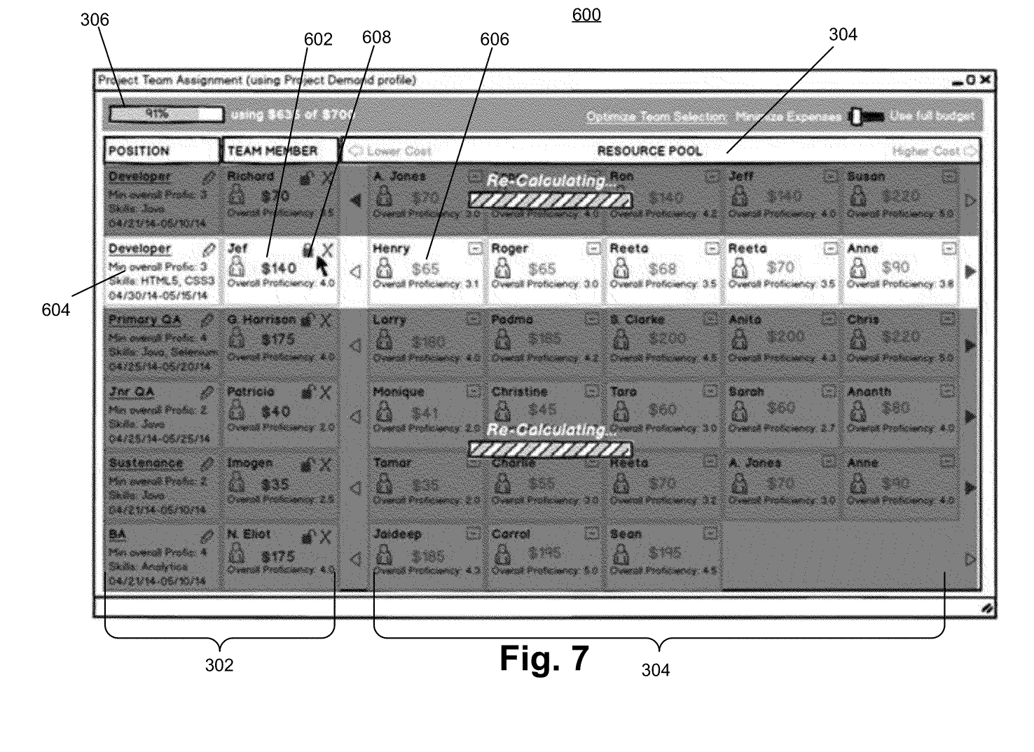

In operation, a user can select a resource to be assigned to the corresponding position by double-clicking its cell. Upon selection, the cell is shifted from resource pool grid 304 to team member column 312 and is “locked”, as shown, for example, in FIGS. 6 and 7. The previously selected resource is returned to the corresponding row of resource pool grid 304 and the list of resources in that row of resource pool grid 304 can be reordered accordingly.

FIG. 4 illustrates an edit requirements dialog 402 of a graphical user interface 400 for optimized selection of a project team, in accordance with one embodiment. Edit requirements dialog 402 allows the user to edit the criteria for staffing the position, such as, for example: position name/role, minimum overall proficiency, start & finish date, and skill(s).

FIG. 5 illustrates a resource details dialog 502 of a graphical user interface 500 for optimized selection of a project team, in accordance with one embodiment. Resource details dialog 502 provides a quick way to see more information about a resource such as, for example: a short bio, educational qualifications, skills and skill proficiencies, resource rates, recent projects and areas of interest. The information displayed by resource details dialog 502 makes it easier for the user to make more informed staffing decisions.

FIGS. 6-8 illustrate manual assignment of a resource 602 to a position 604 by a user of a graphical user interface 600 for optimized selection of a project team, in accordance with one embodiment.

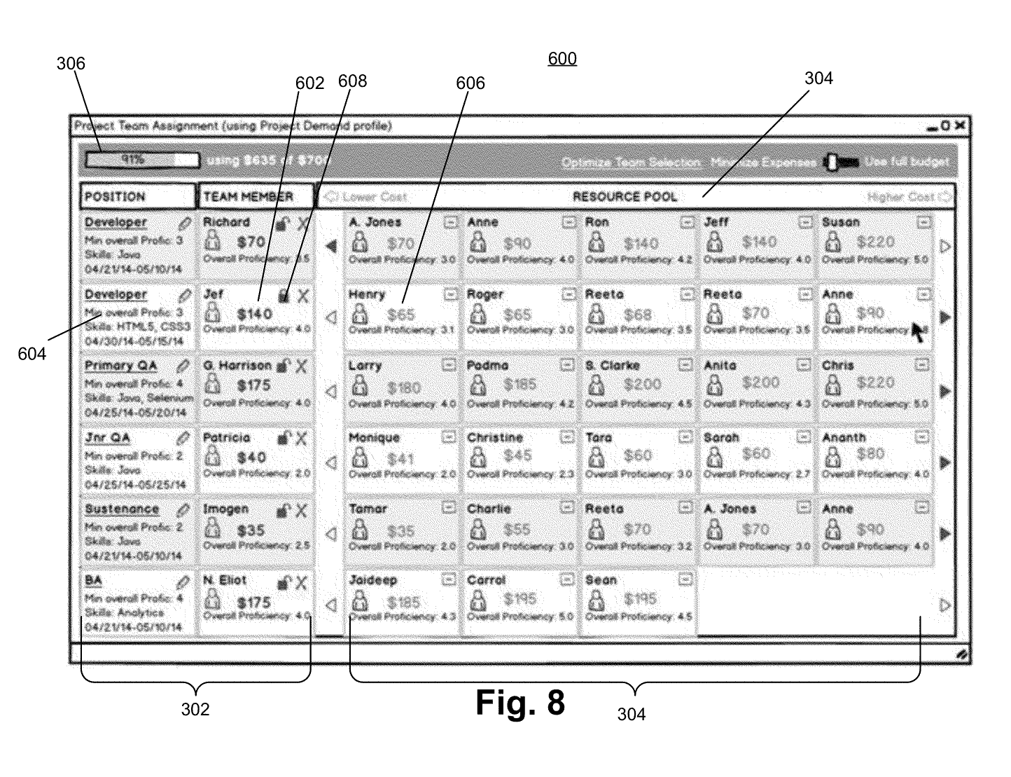

FIG. 6 illustrates a graphical user interface 600 for optimized selection of a project team indicating user selection of resource “Jef” 602, in accordance with one embodiment. A user can select resource “Jef” 602 to be assigned to developer position 604 by double clicking on the resource “Jef” 602 cell. Upon selection, resource “Jef” 602 is assigned to developer position 604 and grids 302 and 304 are updated accordingly as shown, for example, in FIGS. 7 and 8.

FIG. 7 illustrates a graphical user interface 600 for optimized selection of a project team indicating that updated project team assignments are being determined based on a manual user assignment of resource “Jef” 602, in accordance with one embodiment. As discussed above, upon user selection, resource “Jef” 602 is assigned to developer position 604, resource “Henry” 606 goes back to the corresponding row of resource pool grid 304, and auto-generated optimal assignments are re-calculated. Progress bar 306 is also updated upon user selection of resource “Jef” 602 to indicate the change in the amount of the available budget used based on the increased cost of staffing resource “Jef” 602.

FIG. 8 illustrates a graphical user interface 600 for optimized selection of a project team displaying updated resource assignments determined upon manual user assignment of resource “Jef” 602, in accordance with one embodiment. The updated resource assignments include the re-calculated optimal assignments previously discussed in conjunction with FIG. 7.

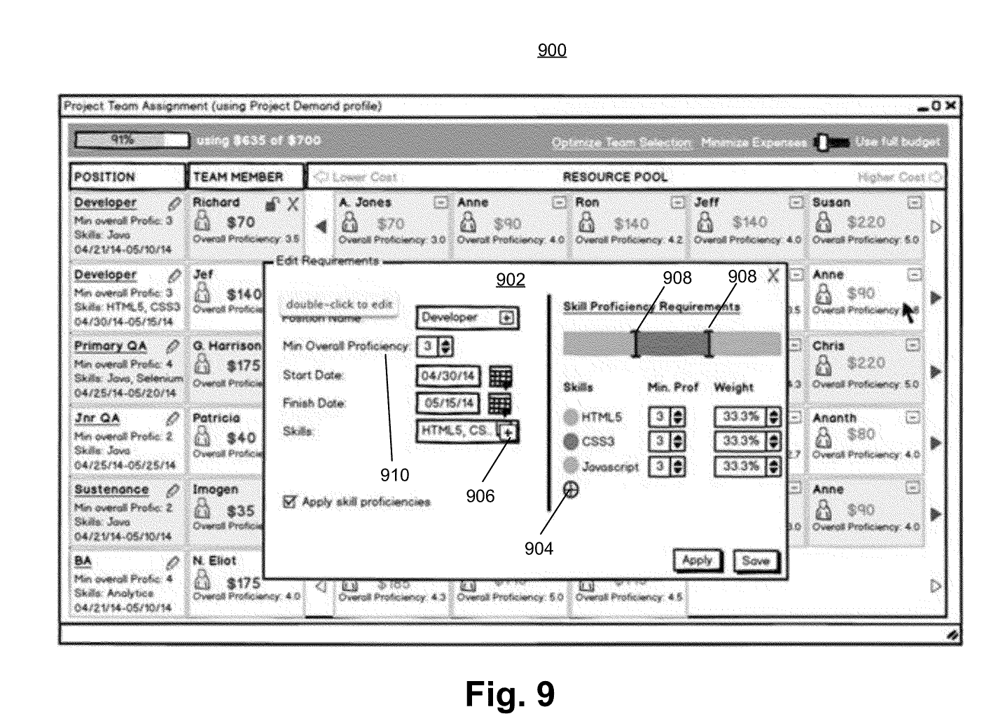

FIG. 9 illustrates an edit requirements dialog 902 of a graphical user interface 900 for optimized selection of a project team including a position requiring multiple skills with equal weighting factors applied by default to each skill, in accordance with one embodiment. Edit requirements dialog 902 allows a user to specify that a position requires a resource that has more than one skill. Edit requirements dialog 902 allows a user to specify a minimum proficiency and a weight for each skill and includes icons 904 and/or 906 which allow a user to add additional skills and sliders 908 which allow a user to graphically set the weights associated with the skills. In some embodiments, the minimum proficiency for a skill is set to zero if left blank. By default all skills have uniform weightage (or weighted factor) which can be adjusted, for example, by sliding the divider between skills (sliders 908) shown on the weightage bar, or explicitly typing in the weightage box next to each skill. When a change is made, the system updates the other weightages proportionally so that the sum of weightages is 100. The minimum overall proficiency 910 criterion is determined by calculating the weighted average of all skill proficiencies.

When the requirements for a position are updated to require multiple skills, the assigned resource and the resources available for that position shown in the corresponding row of team member column 312 and resource pool grid 304 are each updated to show skills and skill proficiencies, and the overall proficiency for each resource is calculated as the weighted average of the resource's skill proficiencies for those skills required by the position.

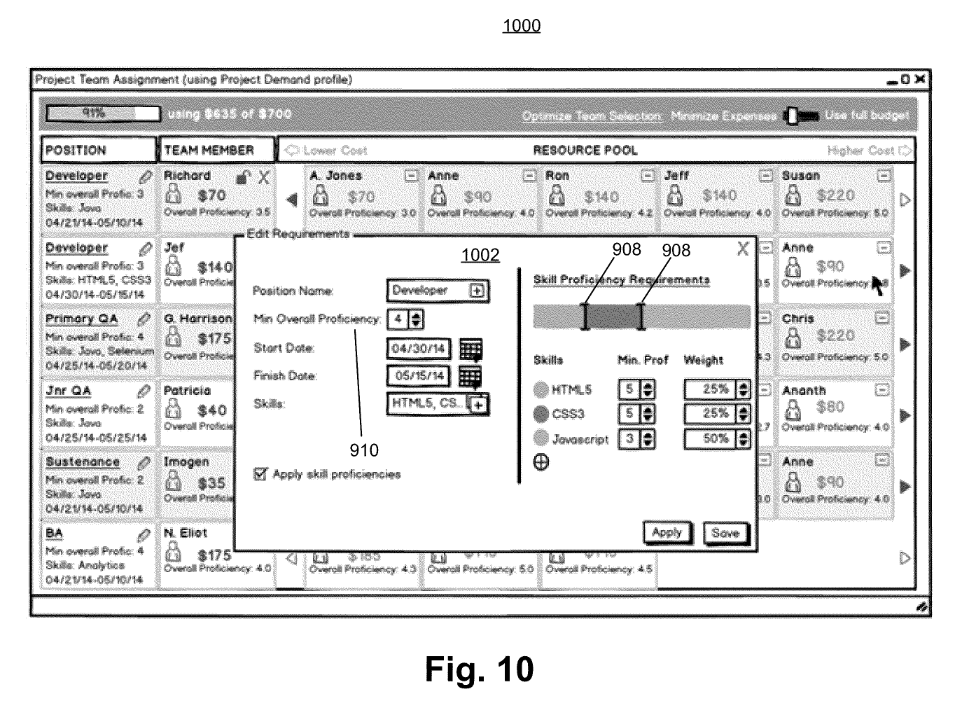

FIG. 10 illustrates an edit requirements dialog 1002 of a graphical user interface 1000 for optimized selection of a project team including a position requiring multiple skills with varying weighting factors applied to each skill, in accordance with one embodiment. Edit requirements dialog 1002 includes sliders 908 and weightage boxes indicating that the weights for each skill have been adjusted and the minimum overall proficiency 910 for the position has been updated accordingly.

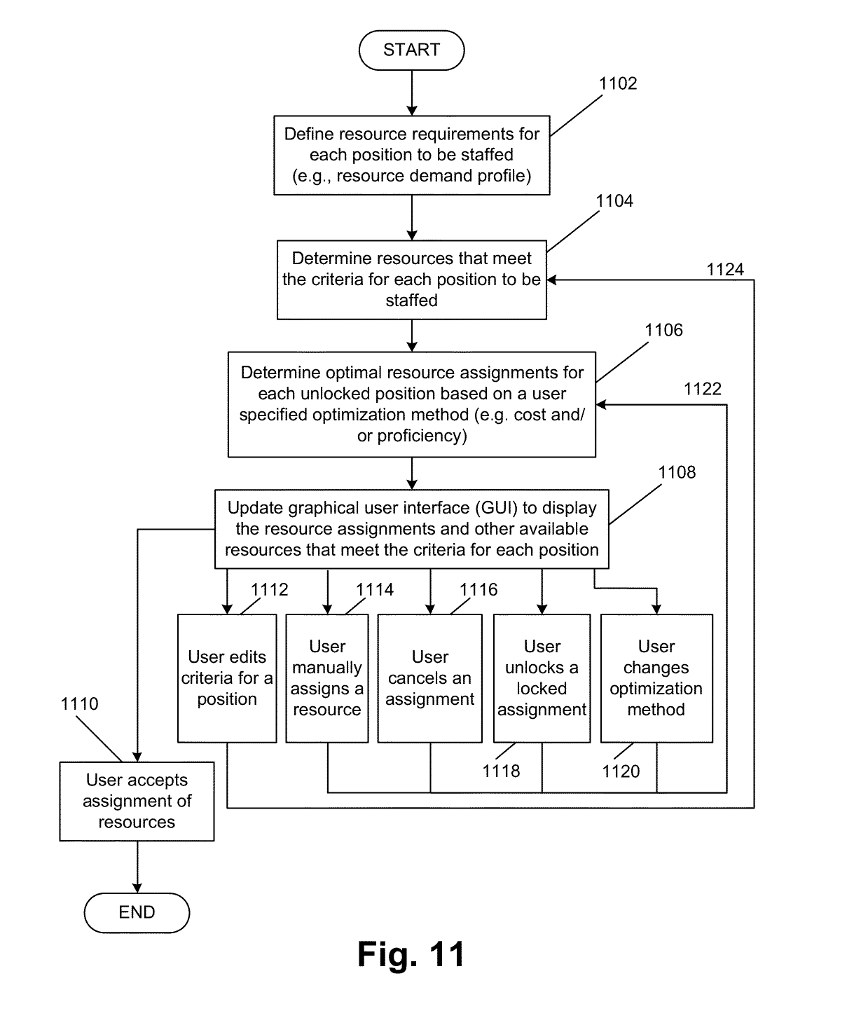

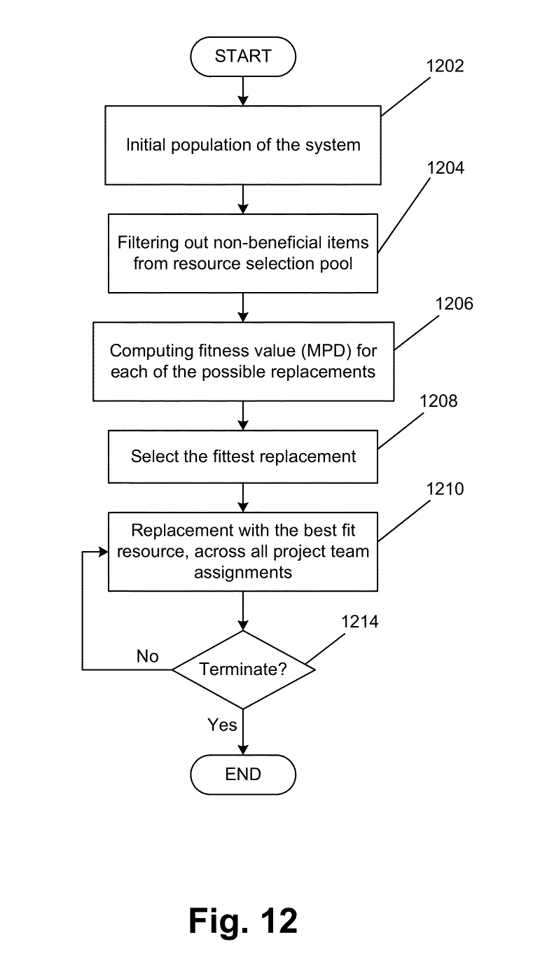

FIG. 11 is a flow diagram showing the functionality for managing a resource assigning graphical user interface in accordance with one embodiment. In one embodiment, the functionality of the flow diagram of FIG. 11, and FIG. 12, is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 1102, resource requirements are defined for each position to be staffed. In some embodiments, a resource demand profile is provided that specifies the requirements for one or more positions to be staffed for a project team. The resource demand profile can also specify the allocated budget for staffing the project team. In some embodiments, module 18 can provide a graphical user interface to allow the user to enter the resource requirements or load previously entered resource requirements (e.g., by entering or loading a resource demand profile similar to resource demand profile 200).

At 1104, module 18 determines which resources meet the criteria for each position by scanning/searching a pool of available resources to generate, for each position, a list of resources that meet the criteria for that position.

Although not shown, in some embodiments, once module 18 has generated a list of eligible resources for each open position, the user is asked whether he wants the system to optimize the selection by cost or by overall proficiency. In some other embodiments, an optimizer is set as the default optimizer.

At 1106, module 18 determines optimal resource assignments for each unlocked position based on a user specified (or a default) optimization method. A cost optimizer fills each open or unlocked position with the cheapest eligible resource to minimize the overall budget consumed. Cost optimizer mode can be activated, for example, when the user selects the “Minimize Expenses” option of optimization mode slider 308 shown in FIG. 3. A proficiency optimizer fills open and unlocked positions such that the sum of proficiencies of all the resources chosen is the highest that is possible without exceeding the given budget. Proficiency optimizer mode can be activated, for example, when the user selects the “Use full budget” option of optimization mode slider 308 shown in FIG. 3. Assignment auto-generated by module 18 are unlocked by default, and every manual selection is locked by default. The optimizers do not change locked assignments but do take locked assignments into account when determining how to optimally fill the open/unlocked positions.

At 1108, module 18 displays/updates a graphical user interface such as, for example, graphical user interface 300 shown in FIG. 3, to display the resource assignments (e.g., auto-generated optimal resource assignments generated at 1106 and/or any manual user assignments) and other available resources that meet the criteria for each position.

At 1112, a user edits criteria for a position. Module 18 can allow users to edit position requirements by displaying an edit requirements dialog such as edit requirements dialog 402 of FIG. 4. Upon user modification of position requirements, the current assignment is voided, the list of eligible resources repopulated, and module 18 selects the optimum resource (e.g., the cheapest eligible or the most proficient affordable) based on the selected optimization mode. When, for example, proficiency optimization mode is selected, a requirement change can have ripple effects on (unlocked) pre-existing assignments.

At 1114, a user manually selects a resource to be assigned to a position. Module 18 can allow users to manually assign a resource to a position when users double click on a resource as shown, for example, in FIGS. 6-8. Upon manual assignment of a resource by a user, module 18 updates and locks the assignment, re-runs the selected optimization service, and updates the amount of the budget consumed.

At 1116, a user cancels an assignment. Users can cancel auto-generated assignments or manual user assignments by, for example, clicking the resource's cross button 316 as shown in FIG. 3. Cancelling an assignment by a user overrides the lock (if present) on the assignment, vacates the position, and causes module 18 to run the selected optimization service to fill the position with a new resource (and may affect other unlocked assignments based on, for example, the optimization mode selected).

At 1118, a user unlocks a locked assignment. Users can unlock a locked assignment by, for example, clicking lock icon 608 as shown in FIGS. 7 and 8. Unlocking an assignment indicates to the selected optimizer that the assignment is free to be updated, and unlocking an assignment causes module 18 to run the selected optimizer.

At 1120, a user changes the selected optimization method. The user can change the selected optimization method by, for example, sliding optimization mode slider 308 to select a different optimization mode. Changing the optimization mode causes module 18 to update all unlocked assignments based on the new mode chosen.

At 1110, a user accepts the present assignment of resources to the positions for the project team.

Although not shown, a user can lock an assignment to indicate that the selected optimizer should not change the particular resource assignment when generating auto-generated optimal assignments.

In some embodiments, the functionality of the flow diagram of FIG. 11 can be repeated in whole or in part, examples of which are shown as 1122 and 1124.

FIG. 12 is a flow diagram showing the functionality for a skills/proficiency optimizer in accordance with one embodiment.

At 1202, module 18 initially staffs all empty or unlocked positions with the cheapest eligible resources (minimizing budget consumption). If the number of unlocked positions in the project team is n, consider the resultant project team assignments to be denoted by R₁, R₂, R₃, . . . Rₙ.

At 1204, module 18 filters out non-beneficial items from resource selection pool. For each given position p (pε{1, 2, 3, . . . n}), the available resource pool is narrowed down to a set S(p) by removing those resources from further consideration, that either have a lower proficiency than Rₚ or will cause overshooting of the total project budget if assigned.

At 1206, module 18 computes a fitness value (“MPD”) for each of the possible replacements. For a given position p (pε{1, 2, 3, . . . n}), each of the k(p) possible replacements is considered one by one (k(p) denotes the number of resources present in S(p)). Fitness values f_{p,1}, f_{p,2}, . . . f_{p,k(p)} are determined by computing the proficiency gained per additional dollar spent on the replacement. For every xε{1, 2, 3, . . . k(p)}:

$${f}_{p , x} = \frac{{proficiencyofx}^{th} resource - {proficiencyofR}_{p}}{{costofx}^{th} resource - {costofR}_{p}}$$

This can be thought of as a way to measure “bang for your buck” and will be referred to as the MPD factor (Marginal Proficiency per Dollar).

At 1208, module 18 selects the fittest replacement. For each position p (pε{1, 2, 3, . . . n}), the replacement that yields the highest MPD factor is marked as R′ₚ and stored along with its MPD (fitness value, fₚ), into an n×2 array (at the p^{th} position).

The following replacement array results: [[R′₁, f₁], [R′₂, f₂], [R′₃, f₃], . . . [R′ₙ, fₙ]].

At 1210, module 18 determines the position with the best fit resource, across all project team assignments. From the replacement array in turn, the resource R′ₘ which has the maximum fitness value or MPD (mε{1, 2, 3, . . . n} such that fₘ=fₘₐₓ=max(f₁, f₂, . . . fₙ)) is found. The corresponding project team assignment Rₘ is replaced with R′ₘ. 1204, 1206, and 1208 are repeated exclusively for the m^{th} position to update the corresponding values in the replacement array with the next fittest replacement resource. For all other positions, 1204 is repeated. If it is found that for a position (or positions), the fittest choice (R′ₚ in the replacement array) has been excluded, 1206 and 1208 are repeated for that/those position(s).

At 1212, module 18 determines whether processing should terminate or whether 1210 should be repeated (including repeating 1204-1208 as needed) to iteratively update the project team until a replacement with higher proficiency can no longer be afforded within the available budget (i.e. until effectively out of budget), or the highest proficiency resources have already been selected. At that point, the optimum team in terms of proficiency has been determined, given the budget constraint.

The superior performance of the functionality of FIG. 12 can be illustrated as follows. Assume there are n positions, and r eligible resources per position. In the worst case, a module (such as module 18) will have to make as many replacements as there are replacement options, which is n×r. And each time, to find the fittest resource for replacement, module 18 will have to go through, at most, n×r choices. Hence, the worst case time complexity of the algorithm is going to be O((nr)²). For n=10 and r=5, module 18 will have to perform at most 2500 steps. For n=11, module 18 shall have, at most, 3025 steps, and for r=6, n=10, module 18 will have 3600 steps. This is clearly superior to the brute force method by several orders of magnitude.

Embodiments provide a novel approach of optimizing the staffing of a project team based on position requirements using Cost Optimization and/or Proficiency Optimization. Such embodiments can include a graphical user interface that displays position information, optimal assignments for each position, and other available resources for each position. The graphical user interface can allow a user to select/change the optimization method, edit resource requirements, and manually override an optimal assignment; and the selected optimization method can be re-run based on and taking into account the user's changes and/or manual overrides.

As disclosed, embodiments comprise a system that auto-generates optimal resource assignments for project team staffing based on a user selected optimization mode and re-calculates optimal assignments based on user input such as modification of position requirements and/or overriding an auto-generated assignment.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, cause the processor to manage resource staffing, the managing comprising:
receiving requirements for one or more positions to be staffed for a project team and an allocated budget for staffing the project team;
selecting, for each position, eligible resources that meet the requirements of the position;
determining optimal resource assignments for the project team based on a selected optimization method, the optimal resource assignments comprising, for each position, a resource assignment of one of the corresponding eligible resources to the position; and
displaying a graphical user interface including the positions, the optimal resource assignments, and the eligible resources.

2. The computer readable medium of claim 1, the managing further comprising:
receiving user input; and
responsive to the receiving:
determining updated optimal resource assignments based on the selected optimization method and the user input; and
updating the graphical user interface to reflect the receipt of the user input and to display the updated optimal resource assignments.

3. The computer readable medium of claim 1, the managing further comprising:
upon user selection of one of the eligible resources to be assigned to the corresponding position, creating and locking a user assignment of the selected one of the eligible resources to the corresponding position; and
responsive to the user selection of the user assignment, determining updated optimal resource assignments for the project team based on the selected optimization method and the locked user assignment, the selected optimization method preserving the locked user assignment such that the updated optimal resource assignments comprise the locked user assignment.

4. The computer readable medium of claim 1, the managing further comprising:
receiving modified requirements for one or more positions; and
responsive to the receiving:
updating the eligible resources based on the modified position requirements;
determining updated optimal resource assignments based on at least the updated eligible resources and the selected optimization method; and
updating the graphical user interface to reflect the modified position requirements and display the updated optimal resource assignments.

5. The computer readable medium of claim 2, wherein the user input comprises a user assignment of a resource to a position, the user assignment is locked, and the selected optimization method preserves the locked user assignment.

6. The computer readable medium of claim 2,
wherein the user input comprises a user cancellation of an optimal resource assignment,
wherein the determining updated optimal resource assignments comprises removing the resource corresponding to the cancelled optimal resource assignment from the corresponding position's eligible resources, and
wherein the updated optimal resource assignments comprises a new assignment of a new resource to the position corresponding to the cancelled optimal resource assignment.

7. The computer readable medium of claim 1, wherein the selected optimization method is a cost optimization method configured to optimize resource selection by cost to select the cheapest resource available that meets a minimum desired proficiency for each position.

8. The computer readable medium of claim 1,
wherein each available resource has one or more skills and a proficiency level for the one or more skills; and
wherein the selected optimization method is a proficiency optimization method configured to optimize resource selection by maximizing the sum total of relevant proficiencies of all assigned resources while staying within the allocated budget.

9. The computer readable medium of claim 6, wherein the proficiency optimization method comprises:
assigning the cheapest eligible resources to all empty or unlocked positions to minimize budget consumption;
selecting, for each position, possible replacements by filtering out non-beneficial items from the position's eligible resources;
computing a fitness value for each of the possible replacements;
selecting, for each position, a fittest replacement having the highest fitness value;
determining a best fit position with a best fit replacement resource having the highest fitness value across all fittest replacements; and
replacing the resource assigned to the best fit position with the best fit replacement resource.

10. A computer-implemented method for managing resource staffing, the computer-implemented method comprising:
receiving requirements for one or more positions to be staffed for a project team and an allocated budget for staffing the project team;
selecting, for each position, eligible resources that meet the requirements of the position;
determining optimal resource assignments for the project team based on a selected optimization method, the optimal resource assignments comprising, for each position, a resource assignment of one of the corresponding eligible resources to the position; and
displaying a graphical user interface including the positions, the optimal resource assignments, and the eligible resources.

11. The computer-implemented method of claim 10, the computer-implemented method further comprising:
receiving user input; and
responsive to the receiving:
determining updated optimal resource assignments based on the selected optimization method and the user input; and
updating the graphical user interface to reflect the receipt of the user input and to display the updated optimal resource assignments.

12. The computer-implemented method of claim 10, the computer-implemented method further comprising:
receiving modified requirements for one or more positions; and
responsive to the receiving:
updating the eligible resources based on the modified position requirements;
determining updated optimal resource assignments based on at least the updated eligible resources and the selected optimization method; and
updating the graphical user interface to reflect the modified position requirements and display the updated optimal resource assignments.

13. The computer-implemented method of claim 11,
wherein the user input comprises at least one of a user assignment of an eligible resource to a corresponding position or a user cancellation of an optimal resource assignment,
wherein, when the user input comprises the user assignment of an eligible resource to a corresponding position:
the computer-implemented method further comprises creating and locking the user assignment of the selected eligible resource to the corresponding position;
the determining updated optimal resource assignments is based on at least the selected optimization method and the locked user assignment, and
the selected optimization method preserves the locked user assignment such that the updated optimal resource assignments comprise the locked user assignment, and
wherein, when the user input comprises the user cancellation of an optimal resource assignment:
the computer-implemented method further comprises removing the resource corresponding to the cancelled optimal resource assignment from the corresponding position's eligible resources; and
the updated optimal resource assignments comprise a new assignment of a new resource to the position corresponding to the cancelled optimal resource assignment.

14. The computer-implemented method of claim 10,
wherein each available resource has one or more skills and a proficiency level for the one or more skills, and
wherein the selected optimization method is a proficiency optimization method configured to optimize resource selection by maximizing the sum total of relevant proficiencies of all assigned resources while staying within the allocated budget.

15. The computer-implemented method of claim 14, wherein the proficiency optimization method comprises:
assigning the cheapest eligible resources to all empty or unlocked positions to minimize budget consumption;
selecting, for each position, possible replacements by filtering out non-beneficial items from the position's eligible resources;
computing a fitness value for each of the possible replacements;
selecting, for each position, a fittest replacement having the highest fitness value;
determining a best fit position with a best fit replacement resource having the highest fitness value across all fittest replacements; and
replacing the resource assigned to the best fit position with the best fit replacement resource.

16. A system comprising:
a memory device configured to store a resource staffing module;
a processing device in communication with the memory device, the processing device configured to execute the resource staffing module stored in the memory device to manage resource staffing, the managing comprising:
receiving requirements for one or more positions to be staffed for a project team and an allocated budget for staffing the project team;
selecting, for each position, eligible resources that meet the requirements of the position;
determining optimal resource assignments for the project team based on a selected optimization method, the optimal resource assignments comprising, for each position, a resource assignment of one of the corresponding eligible resources to the position; and
displaying a graphical user interface including the positions, the optimal resource assignments, and the eligible resources.

17. The system of claim 16, the managing further comprising:
receiving user input; and
responsive to the receiving:
determining updated optimal resource assignments based on the selected optimization method and the user input; and
updating the graphical user interface to reflect the receipt of the user input and to display the updated optimal resource assignments.

18. The system of claim 16, the managing further comprising:
receiving modified requirements for one or more positions; and
responsive to the receiving:
updating the eligible resources based on the modified position requirements;
determining updated optimal resource assignments based on at least the updated eligible resources and the selected optimization method; and
updating the graphical user interface to reflect the modified position requirements and display the updated optimal resource assignments.

19. The system of claim 16,
wherein each available resource has one or more skills and a proficiency level for the one or more skills, and
wherein the selected optimization method is a proficiency optimization method configured to optimize resource selection by maximizing the sum total of relevant proficiencies of all assigned resources while staying within the allocated budget.

20. The system of claim 19, wherein the proficiency optimization method comprises:
assigning the cheapest eligible resources to all empty or unlocked positions to minimize budget consumption;
selecting, for each position, possible replacements by filtering out non-beneficial items from the position's eligible resources;
computing a fitness value for each of the possible replacements;
selecting, for each position, a fittest replacement having the highest fitness value;
determining a best fit position with a best fit replacement resource having the highest fitness value across all fittest replacements; and
replacing the resource assigned to the best fit position with the best fit replacement resource.
